(19) United States
(12) Patent Application Publication
(10) Pub. No.: US 2026/0319945 A1
(43) Pub. Date: Oct. 15, 2026

(54) Sense Amplifier and Method for High Speed Multilevel Sensing in a Flash Memory

(71) Applicant: Infineon Technologies LLC, San Jose, CA (US)

(72) Inventors: Alexander KUSHNARENKO, Haifa (IL); Yoram Betser, Mazkeret-Batya (IL)

(73) Assignee: Infineon Technologies LLC, San Jose, CA (US)

(21) Appl. No.: 19/174,782

(22) Filed: Apr. 9, 2025

(51) Int. Cl. G06F 12/02

(52) U.S. Cl. CPC G06F 12/0246

(57) ABSTRACT

A sensing circuit and method are provided for high speed sensing of multilevel cells (MLCs). Generally, the circuit includes a data sense amplifier (SA) switchably coupled to one of a plurality of MLC in a memory array to receive a data current therefrom and to develop a data signal, m reference SAs, each coupled to a different reference cell to receive a current and develop a reference signal, and a latching segment with m latches. Each latch has a first input coupled in parallel to the data SA, a second input to a different reference SA, and is operable to simultaneously receive and compare the data signal with one of the m different reference signals, and to output one of m latching signals that when collectively decoded are converted to a n-bit binary number representing data stored in the MLC, and where m is equal to 2ⁿ−1.

### TECHNICAL FIELD

The present invention relates generally to the field of computer memories, and more particularly to fast sense amplifiers and methods for sensing multilevel signals from multilevel storage cells.

### BACKGROUND

Sense amplifiers are used in a wide range of integrated circuits (IC), including Non Volatile Memories (NVM), such as flash memory, to compare a signal from a memory or data cell to a reference signal and output a result indicating data stored in the cell.

Generally, an NVM or flash memory includes an array composed of multiple memory or data cells and reference cells, a controller and additional ancillary circuitry. In addition to sense amplifiers, the ancillary circuitry typically includes an input-output (I/O) interface, and address decoding circuits to select or address one or more data cells for an erase, program or read operation.

Figures of merit computer memories include cost, memory size or area occupied on the IC, data storage capacity, and read access times. One way to increase data storage capacity is to increase data density by multilevel data cells (MLC) that are programmable to store more than a single bit of information per cell. For example flash data cells may be programmable to 2, 3, 4 or more bits of data.

The conventional way to implement NVM or flash memories having MLC cells is to add additional SAs for smaller array segments, each SA configured to compare a signal from the MLC cell to a single one of multiple reference signals. This leads to a significant increase in the memory area and power consumption, with consequent increases in cost. Moreover, because the comparison of the signal from a MLC cell to multiple predefined reference signals are performed sequentially and iteratively, read access times are undesirably increased.

Accordingly, there is a need for flash memories including multilevel sense amplifier circuitry for reading multilevel cells having high data densities, and a relatively small area. It is further desirable that the sensing circuitry is fast and efficient reduced with read access times and power consumption.

### SUMMARY

The present invention provides sensing circuits and methods for high speed multilevel sensing in a non-volatile memory (NVM), such as a flash memory.

Generally, the circuit includes a data sense amplifier (SA) switchably coupled to one of a plurality of MLC in a memory array to receive a data current therefrom and to develop a data signal, m reference SAs, each coupled to a different reference cell to receive a current and develop a reference signal, and a latching segment with m latches. Each latch has a first input coupled in parallel to the data SA, a second input to a different reference SA, and is operable to simultaneously receive and compare the data signal with one of the m different reference signals, and to output one of m latching signals that when collectively decoded are converted to a n-bit binary number representing data stored in the MLC, and where m is equal to 2ⁿ−1.

Preferably, the sensing circuit further includes m data SAs and m latching segments, each of the m data SAs having an input switchably coupled to a different one of the plurality of MLCs and an output coupled in parallel to the m latches in a different one of the m latching segments, wherein the circuit is operable to simultaneously sense multibit data stored in m MLCs. More preferably, the sensing circuit further includes a global decoder coupled to outputs of the m latches in all m latching segments to convert the m latching signals from each of the m latching segments into m n-bit binary numbers simultaneously.

In some embodiments, the data SAs and the reference SAs are open or single ended current SAs and include an offset cancelation circuit including an offset compensation capacitor coupled between a gate terminal of a gain transistor and switchably coupled between a voltage source and the input to the sense amplifier, the compensation capacitor operable to store a threshold voltage the gain transistor, and offset a voltage applied to the gate terminal so that signals output from the n data sense amplifiers are common mode insensitive (CMI) signals.

A method of operating a sensing circuit for high speed sensing of data stored in a multilevel data cell (MLC) is also disclosed. Briefly, the method begins with developing in data sense amplifier a data signal (CMI) from a current through a multilevel data cell, while concurrently developing a plurality of reference signals, each different from the others. Next, the data signal is coupled in parallel to first inputs of a plurality of latches while a different one of each of the reference signals to second inputs of the latches. The data signal is simultaneously compared to each of the reference signals in the latches, and latch signals resulting from the comparison output from each of the n latches. Finally, the m latch signals output from the latches as a result of the comparison are decoded to provide a multibit binary number representing data stored in the a multilevel data cell.

According to some embodiments, the data sense amplifier is a single ended current sense amplifier including an offset cancelation circuit, and developing the data signal is accomplished using a time domain sensing approach. Briefly, the offset cancelation circuit includes a transistor and an offset capacitor (CAP_{OFS}) having a first terminal coupled to the MLC and an integration capacitor (CAP_{INT}). The time domain sensing includes three phases. In a first phase the MLC is decoupling from the CAP_{OFS}, charging the CAP_{OFS} and discharging the CAP_{INT}. In a second phase coupling the MLC and the first terminal of the CAP_{OFS} a bit-line voltage (V_{BL}), coupling a source of the transistor to a voltage supply (Vs), and coupling a second terminal of the CAP_{OFS} to a gate and drain of the transistor to discharge the second terminal of the CAP_{OFS} to a voltage equal to Vs minus a threshold voltage (V_{TH}) of the transistor. Finally, in a third phase decoupling the first terminal of the CAP_{OFS} from the V_{BL}, decoupling the second terminal of the CAP_{OFS} from the drain of the transistor, and coupling the drain of the transistor to the CAP_{INT}, whereby a cell current through the MLC discharges the bit-line and boost down the first terminal of the CAP_{OFS} while the second terminal of the CAP_{OFS} coupled to the gate controls a charge current through the transistor to develop a data signal on the CAP_{INT} having a rise time proportional to the cell current.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts. Further, the accompanying drawings, which are incorporated herein and form part of the specification, illustrate embodiments of the present invention, and, together with the description, further serve to explain the principles of the invention and to enable a person skilled in the relevant art(s) to make and use the invention.

FIG. 1 illustrates an exemplary threshold voltage (V_{TH}) distribution for a multilevel cell capable of storing two bits per data cell (2-BPC);

FIG. 2A is a block diagram illustrating a Non Volatile Memory (NVM) or flash memory with an array divided into sectors, each sector including multiple groups of data and reference cells and sense circuitry operable to sense data stored in multilevel cells, and each sector further divided into sub-sectors;

FIG. 2B is a block diagram of a sub-sector of one sector in the flash memory shown in FIG. 2A;

FIG. 3 are timing diagrams illustrating a time domain sensing approach for sensing two-bit data stored in a single multilevel cell of the sub-sector shown in FIG. 2B;

FIG. 4A is a block diagram of a portion of one sub-sector in FIG. 2B illustrating operation of an embodiment of the local decoder;

FIG. 4B is a table illustrating latch and data outputs for the embodiment of the local decoder shown in FIG. 4A operating using a time domain sensing approach;

FIG. 5A is a block diagram of a portion of one sub-sector in FIG. 2B illustrating operation of another embodiment of the local decoder;

FIG. 5B is a table illustrating latch and data outputs for the embodiment of the local decoder shown in FIG. 5A operating using a time domain sensing approach;

FIG. 6A is a block diagram illustrating an embodiment of sensing circuitry connected to a core cell and a number of reference inputs, the sensing circuitry including a sense amplifier with a transistor and offset cancelation mechanism;

FIG. 6B is a schematic block diagram of the sense amplifier with offset cancelation and latching segment of the sensing circuitry of FIG. 6A;

FIG. 7A is timing diagram illustrating operation of switches in the offset cancelation and latching segments of FIG. 7B during a read or sensing operation;

FIG. 7B is a schematic block diagram illustrating a configuration of the offset cancelation and latching segments of during a first or standby phase of the read operation;

FIG. 7C is a schematic block diagram illustrating a configuration of the offset cancelation and latching segments of during a second or bit-line charging and offset cancelation phase of the read operation;

FIG. 7D is a schematic block diagram illustrating a configuration of the offset cancelation and latching segments of during a third or signal development phase of the read operation;

FIG. 8A is a schematic block diagram of another embodiment of a sub-sector of in the flash memory operable to enable three-bit per cell (3-bit/cell) sensing;

FIG. 8B is a schematic block diagram of a latching segment of the sub-sector of FIG. 8A; and

FIG. 9 a flowchart illustrating a method for high speed multilevel sensing in flash memories with offset cancellation.

### DETAILED DESCRIPTION

A sense amplifier and method are provided for high speed multilevel sensing in a flash memory. The sense amplifier and methods of the present disclosure are particularly useful for non-volatile memories (NVM), such as a floating gate or charge trap flash memory in which data is stored in as a charge that alters a threshold voltage of a transistor in the data cell.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification, discussions utilizing terms such as “processing”, “computing”, “calculating”, “determining”, or the like, refer to the action and/or processes of a circuit or similar electronic computing device, that manipulate and/or transform data represented as physical, such as electronic, quantities within the circuits elements into other data similarly represented as physical quantities within the circuit's elements.

Unless specifically stated otherwise, as apparent from the following discussions, it is appreciated that throughout the specification discussions utilizing terms such as charging and/or discharging both actions may be interchangeable. Generally, they both refer to changing the amount of electrical charge stored in the capacitor. When either charging or discharging is discussed, it is understood that one may be replaced with the other with appropriate modifications being made where applicable.

For the purposes of this application the term ‘respective’ or ‘respectively’ is used to indicate the appropriate corresponding element and to mean ‘in the same order’. For example ‘a first and second block may be associated with first and second transistors respectively” may also be read: ‘A first block may be associated with a first transistor and a second block may be associated with a second transistor’. Similarly, the original sentence may be phrased: ‘First and second block may be associated with respective first and second transistors’ and have the same meaning as discussed above.

The present invention provides sensor or sensing circuits with fast sense amplifiers and methods for sensing multilevel signals from multilevel storage cells. The sensing circuits and methods are particularly useful in non-volatile memories (NVM), such as charge-trapping or flash memories, which may be implemented either as discrete integrated circuits (ICs) or as embedded memories in other types of IC, such as microcontroller ICs.

Briefly, a non-volatile or flash memory includes a memory core with a large number of core cells arranged as a two-dimensional data array, and a number of ancillary circuits integrally formed with the core including a row decoder, column decoder, a memory controller and a number of input-output (I/O) circuits or interfaces. The core cells include a large number of memory or data cells, each capable of storing one or more binary bits of data. The data cell includes one or more floating gate or charge trapping transistors with a memory gate that can store a number of electrons or charge. The charge stored on the memory gate determines a turn-on or threshold voltage (V_{TH}) at which the transistor begins to conduct current. Thus, the data stored in the data cell is defined and determined by its V_{TH}, which is programmed by charge stored on the memory gate. For a single level cell (SLC), there generally are two program levels, “erase” and “program”. For a multilevel cell (MLC) there are four or more program levels, and thus two or more bits of information can be stored on each MLC. Generally, a multilevel cell capable of storing n bits of data has 2ⁿ program levels, and in order to determine the state (program level) of the data cell, the data cell's V_{TH} is compared to that of 2ⁿ−1 reference cells whose V_{TH} level is set, or otherwise known.

Thus, for an NVM or flash memory with multilevel cells capable of storing two bits of data (n=2) the V_{TH} of each data cell can be programmed to 2ⁿ or four (4) separate states, and requires 2ⁿ−1 or three (3) different reference voltages to discriminate between the 2ⁿ possible cell states. Each cell state corresponds to a non-overlapping threshold voltage window, separated by non-overlapping spaces in which the reference voltages are located. That is, although data cells programmed to the same n-bit value may not have the exact same V_{TH}, they will have V_{TH} they can be graphed such that the V_{TH} of each cell falls into the same V_{TH} window. A graph of V_{TH} windows and non-overlap space therebetween for a multilevel flash memory is referred to as a V_{TH} distribution.

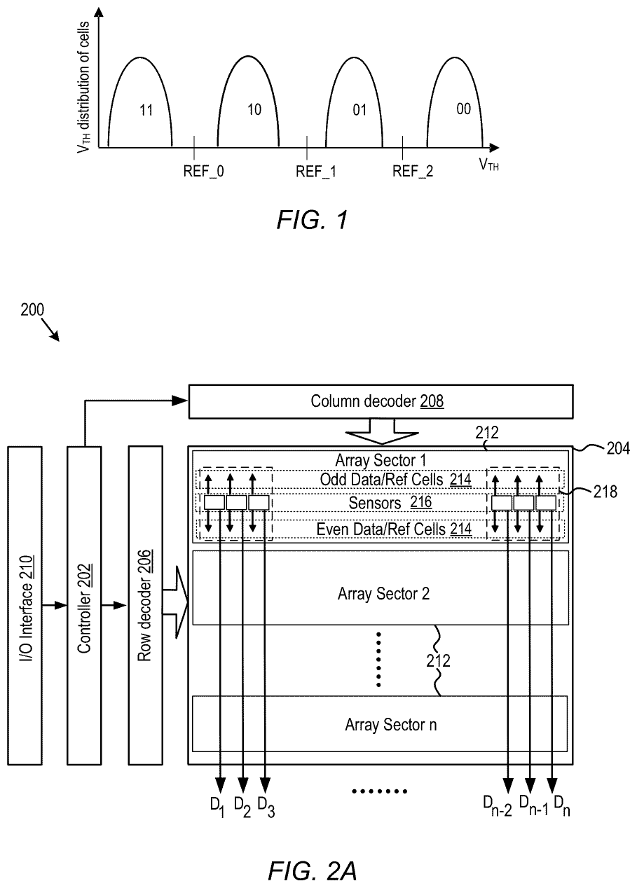

FIG. 1 illustrates an exemplary V_{TH} distribution for a multilevel storage cell (MLC) capable of storing two bits per data cell (2-BPC), or n=2. Referring to FIG. 1 it is seen there are 2ⁿ or four possible program levels or states represented by four possible V_{TH} windows distributions labeled 11, 10, 01 and 00, separated by 2ⁿ−1 reference voltages, REF_0, REF_1 and REF_2. To read out or sense data stored in the cell a voltage (V_{MG}) is applied to a gate of the memory transistor, and the resulting current on a bit-line of the cell, also known as drain or cell current (Ic) compared to that from three reference structures or reference cells to determine the threshold or turn on voltage of data cell. In the embodiment illustrated, the program level 11 has the lowest V_{TH} or highest Ic, the program level 10 has a higher V_{TH}, the program level 01 has a yet higher V_{TH}, and the program level 00 has a yet higher V_{TH} or the lowest Ic.

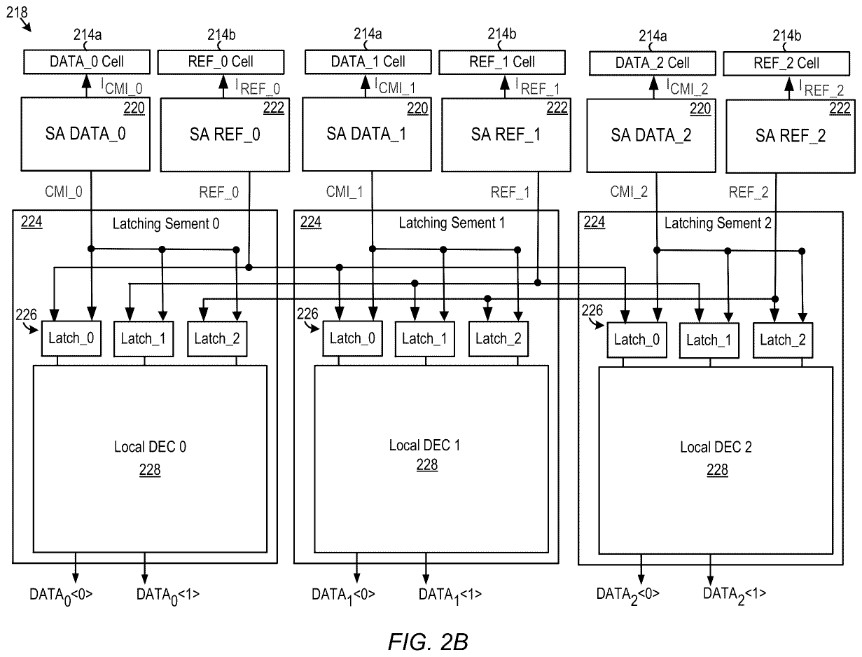

A functional block diagram of an embodiment of a NVM or flash memory is shown in FIG. 2A. Referring to FIG. 2A, the NVM 200 comprises a memory control circuit (controller 202); an array 204, a row decoder 206, a column decoder 208, and an input/output (I/O) interface 210. Typically the array 204 is logically divided into a number of sectors 212 each including a number of core cells 214 and a number of sensing circuits or sensors 216. In some embodiments, such as that shown, the core cells 214 are logically divided into even and odd addressed cells. Generally, each sector 212 in the array 204 is further divided into a number of sub-sectors 218, each including multiple data cells 214a and reference cells 214b, and a sensing circuit 216a.

A functional block diagram of one such sub-sector 218 suitable for sensing or reading data stored in a two bit multilevel cell (2-BPC) is shown in FIG. 2B. Referring to FIG. 2B, where n (the number of bits stored per cell) is two (2) the sensing circuit includes a number (m) or data sense amplifiers (SA DATA 220), where m is generally equal to 2ⁿ−1, or three (3) as shown and an equal number of m reference sense amplifiers (SA REF 222) and m latching segments 224. The data sense amplifiers 220 and reference sense amplifiers 222 are open or single ended current sense amplifiers with an input coupled, respectively, to data cells 214a or reference cells 214b in the array 204. Each of the data sense amplifiers 220 are selectively coupled to a bit-line of one of the data cells 214a addressed by the controller 202 through the row decoder 206 and column decoded 208, and are operable to output a common mode insensitive (CMI) signal having a rise time proportional to a data cell current (I_{CMI}) through the bit-line. Similarly, in the embodiment shown the each of the reference sense amplifiers 222 are coupled to a bit-line of one of the reference cells 214b, are operable to output a reference (REF) signal having a rise time proportional to a reference cell current (I_{REF}) through the bit-line.

Each of the three latching segments 224 include a m or 2ⁿ−1 latching circuits or latches 226, shown here as three (3). The three latches 226 in each latching segment 224 include a first input coupled in parallel to an output of a single one of the data sense amplifiers 220, and a second input coupled to an output of a different one of the reference sense amplifiers 222. Each of the latches 226 in one of the latching segments are operable to simultaneously receive and compare the data signal (CMI_0, CMI_1, CMI_2) received from one of the data sense amplifiers 220 and one of the different reference signals (REF_0, REF_1, REF_2) from one of the reference sense amplifiers 222.

In some embodiments, such as that shown, each of the latching segments further include a local decoding circuit or decoder 228 coupled to outputs of the latches 226. The local decoder 228 includes combinational logic elements (not shown in this figure) configured and operable to decode signals from the latches 226 to provide a multibit binary number representing data stored in the data cell 214a sensed by the associated data sense amplifiers 220.

It is noted that although there is a small area impact due to additional latches 226 per associated data sense amplifiers 220, three (3) latches instead of one (1) latch as in a conventional flash memory with single level cells (SLCs), a data density of the NVM or flash memory 200 disclosed herein is increased by a factor of two or more, depending on the program levels of the MLC used. It is further noted that because the data signals received from the data sense amplifiers 220 are simultaneously compared to each of the different reference signals received from the reference sense amplifiers, the read access times for the disclosed flash memory 200 are substantially less than for conventional MLC flash memories in which multiple comparisons against each different reference signal are made sequentially.

Additionally, it is noted that because a data path coupling the data cell to the data sense amplifier, and the path coupling the data sense amplifier to one of the latching segments are substantially electrically matched to the paths coupling the reference cells to the reference sense amplifiers and the latching segments, the read access times for the disclosed flash memory 200 is further reduced. Finally, it is noted that because each of the data sense amplifiers 220 and reference sense amplifiers 222 are electrically coupled to an equal number of latches 226 in the latching segments 224 both read access times and accuracy are further improved.

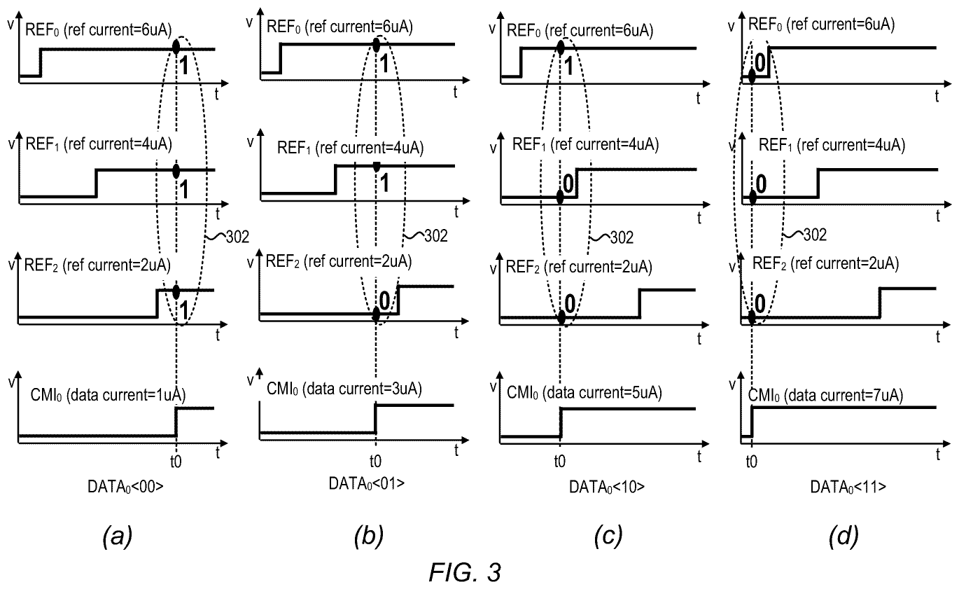

FIG. 3 illustrates a time domain sensing approach for sensing two-bit data stored in a single multilevel data cell 214a of the sub-sector 218 shown in FIG. 2B. Referring to FIGS. 2B and 3, the outputs of the data sense amplifiers 220 (CMI_0, CMI_1, CMI_2) and reference sense amplifiers 222 (REF_0, REF_1, REF_2) switch from a low voltage (0) to a high voltage (1) after a time proportional to the current (I_{CMI}) through the associated or selected data cell 214a or the current (I_{REF}) through the reference cell 214b. Each of the latches 226 (Latch_0, Latch_1 and Latch_2) compare a data output (e.g., CMI_0) to one of the reference outputs (REF_0, REF_1, REF_2), and if the reference output is greater than the data output, the latch (Latch_0, Latch_1, Latch_2) output a high or logic ‘1’, otherwise the output is a low or logic ‘0’. Each latch (Latch_0, Latch_1, Latch_2) provides a latch output signal to the local decoder 228 to decode signals from the latches that, depending on a configuration of the decoder, directly outputs a 2-bit binary number representing data stored in the data cell 214a, or output a multibit digital signal that can be interpreted in a separate logic block in memory 200 (not shown) to provide the 2-bit binary number.

Referring to FIGS. 2B and 3, in an exemplary embodiment a first reference cell (REF_0 Cell) provides an reference current (I_{REF_0}) of 6 μA to a first reference sense amplifier 222 (SA REF_0), a second reference cell (REF_1 Cell) provides a current of 4 μA to a second reference sense amplifier (SA REF_1), and a third reference cell (REF_2 Cell) provides a current of 2 μA to a third reference sense amplifier (SA REF_2). It is noted that these current values for the reference cells 214b are determined by the technology, such as CMOS, used to fabricate the memory 200, and remain substantially constant over the operating life of the memory.

Referring to part (a) of FIG. 3 it is seen that for a data cell 214a (DATA_0 Cell) with a sense or bit-line data current (I_{CMI_0}) of 1 μA when read by a first data sense amplifier 220 (SA DATA_0) provides an output signal (CMI_0) that switches from a low voltage (0) to a high voltage (1) at time (t0) when all of the reference sense amplifiers 222 provide outputs (REF_0, REF_1, REF_2) that are already high. Thus, output signals 302 of all latches 226 are a high or logic ‘1’, and are decoded in the local decoder 228, or further interpreted in the separate logic block, to provide a data out of DATA₀ <00>.

Referring to part (b) of FIG. 3, if I_{CMI_0} of 3 μA is between I_{REF_1} and I_{REF_2}, at time t0 when CMI_0 switches from a low voltage (0) to a high voltage (1), latch output signals 302 for the first latch (Latch_0 in FIG. 2B) and the second latch (Latch_1) are ‘1’, and for third latch (Latch_2) is ‘0’, and the data out is decoded or interpreted as DATA₀ <01>.

Referring part (c) of FIG. 3, if I_{CMI_0} of 5 μA is between I_{REF_0} and I_{REF_1}, at time t0 when CMI_0 switches from a low voltage (0) to a high voltage (1), latch output signals 302 for the Latch_0 is ‘1’, and for Latch_1 and Latch_2 are ‘0’, and the data out is decoded or interpreted as DATA₀ <10>.

Finally, referring to part (d) of FIG. 3, if I_{CMI_0} of 7 μA is greater than I_{REF_0} and I_{REF_1}, and I_{REF_2} at time t0 when CMI_0 switches from a low voltage (0) to a high voltage (1), latch output signals 302 for all latches 226 (Latch_0, Latch_1, Latch_2) are ‘0’, and the data out is decoded or interpreted as DATA₀ <11>.

The above is an example to explain operation detail of one embodiment of the latching segments 224 and local decoders 228. In this example, cells having the highest bit-line data current I_{CMI} (see part (d) of FIG. 3) is assigned the highest data out as DATA<11>. It will be the understanding that, in some embodiments, cells having the lowest bit-line data current I_{CMI} may be read/decoded as having the highest data out as DATA<11> without deviating from the principle of this disclosure.

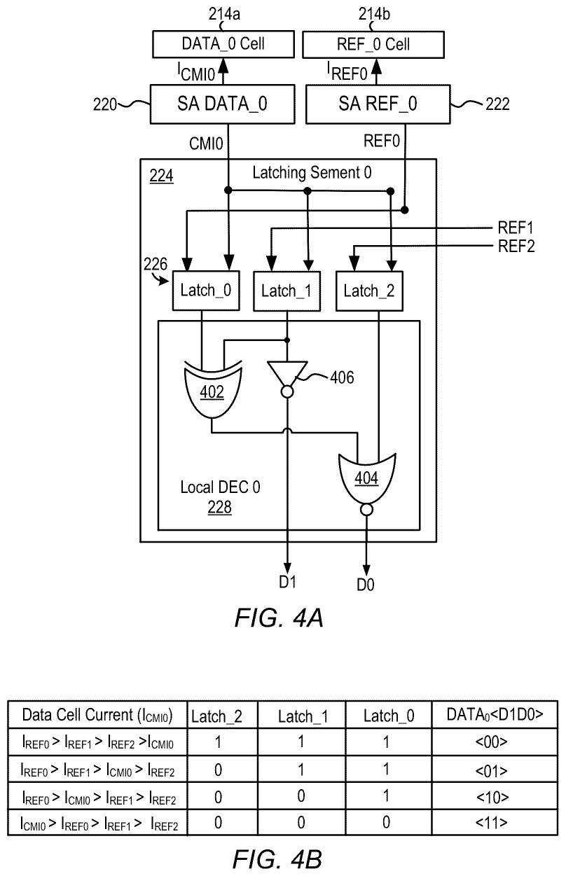

Operation of an exemplary embodiment of a local decoder 228 will now be explained in detail with reference to FIGS. 4A and 4B. FIG. 4A is a block diagram of a portion of the sub-sector 218, shown on the left side in FIG. 2B. FIG. 4B is a table summarizing illustrating latch and data outputs for a single data sense amplifier 220 (SA DATA_0) of a sub-sector 218 of a memory, shown on the left side in FIG. 2B, when operating using a time domain sensing approach.

Referring to FIGS. 4A and 4B, it is noted that where the data cell current (I_{CMI0}) is less than all of the reference currents (I_{REF0}, I_{REF1}, and I_{REF2}) the output of all latches 226 (Latch_0, Latch_1, Latch_2) is a logic high or ‘1’. Referring to FIG. 4A it is seen that when the outputs from Latch_0 and Latch_1 to an exclusive or XOR gate 402 are both ‘1’, the output from the XOR gate is ‘0’, which is coupled to a first input of a NOR gate 404. Because a second input to the NOR gate 404 from Latch_2 is ‘1’ the output of the NOR gate is ‘0’, so that a first digital output signal or bit (D0) is also ‘0’. Furthermore, it is seen that a second digital output signal or bit (D1) is dependent solely on the output of Latch_1, in the present example a ‘1’, which is inverted by an inverter 406 so that D1 is also ‘0’. Thus, in this embodiment the local decoder 228 directly provides a 2-bit binary number output (Data₀<D1D0>), shown <00> in a first row of FIG. 4B, without the need for further interpretation by a separate logic block.

Referring again to FIGS. 4A and 4B, where the data cell current (I_{CMI0}) is greater than I_{REF2} but less than I_{REF0} and I_{REF1}, the output of Latch_2 is ‘0’, and the output of Latch_0 and Latch_1 are both ‘1’. Because the output of Latch_0 and Latch_1 are both ‘1’, the output of the XOR gate 402 is ‘0’, which is coupled to the first input of the NOR gate 404. Because the second input to the NOR gate 404 from Latch_2 is also ‘0’ the output of the NOR gate is ‘1’ so that D0 is ‘1’. The output of Latch_1, ‘1’, is inverted by inverter 406 so that D1 is ‘0’, to provide a Data₀<D1D0> of <01>, as shown in a second row of FIG. 4B.

Where I_{CMI0} is greater than I_{REF1} and I_{REF2} but less than I_{REF0}, the outputs of Latch_2 and Latch_1 are both ‘0’, and the output of Latch_0 is ‘1’. The output of the XOR gate 402 is ‘1’, which is coupled to the first input of the NOR gate 404. Because the second input to the NOR gate 404 from Latch_2 is ‘0’ the output of the NOR gate is ‘0’ so that D0 is ‘0’. The output of Latch_1, ‘0’, is inverted by inverter 406 so that D1 is ‘1’, to provide a Data₀<D1D0> of <10>, as shown in a third row of FIG. 4B.

Finally, where I_{CMI0} is greater than all the reference currents (I_{REF0}, I_{REF1}, I_{REF2}) the output of all latches 226 (Latch_0, Latch_1, Latch_2) is ‘0’, the output of the XOR gate 402 is ‘0’, which is coupled to the first input of the NOR gate 404. Because the second input to the NOR gate 404 is also ‘0’, the output of the NOR gate is ‘1’, to provide a D0 of ‘1’. D1 like Latch_1 is ‘0’. The output of Latch_1, ‘0’, is inverted by inverter 406 so that D1 is ‘1’, to provide a Data₀<D1D0> of <11>, as shown in a last row of FIG. 4B.

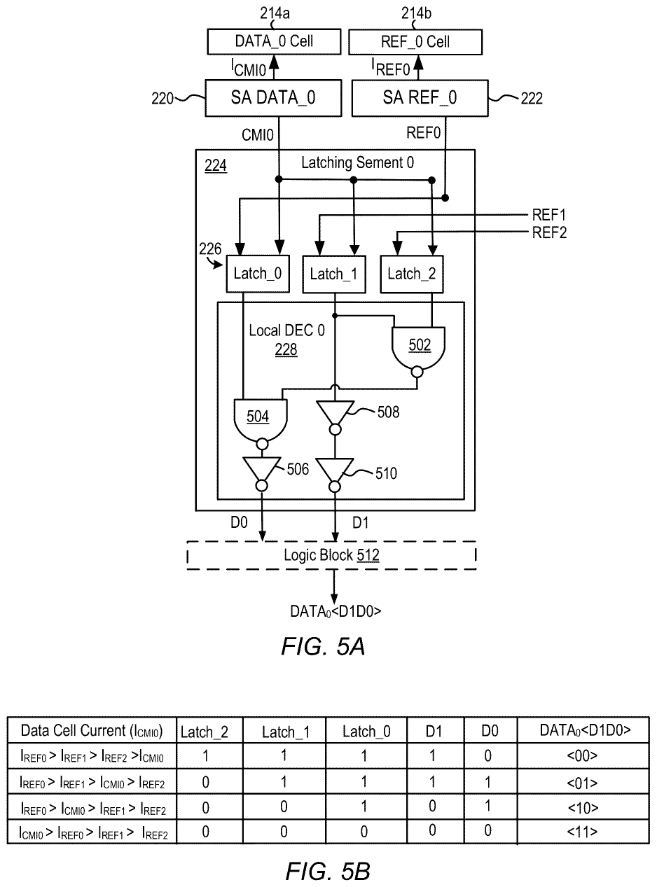

Operation of another embodiment of a local decoder 228 that eliminates the XOR gate 402 of the previous embodiment, thereby reducing the area impact of the local decoder 228 will now be explained in detail with reference to FIGS. 5A and 5B. FIG. 5A is a block diagram of a portion of the sub-sector 218, shown on the left side in FIG. 2B. FIG. 5B is a table summarizing illustrating latch and data outputs for a single data sense amplifier 220 (SA DATA_0) of a sub-sector 218 of a memory, shown on the left side in FIG. 2B, when operating using a time domain sensing approach.

Referring to FIGS. 5A and 5B, it is noted that where the data cell current (I_{CMI0}) is less than all of the reference currents (I_{REF0}, I_{REF1}, and I_{REF2}) the output of all latches 226 (Latch_0, Latch_1 and Latch_2) is a logic high or ‘1’. Referring to FIG. 5A it is seen that when the inputs from Latch_1 and Latch_2 to a first NAND gate 502 are both ‘1’, the output from the first NAND gate is a logic low or ‘0’, which is coupled to a first input of a second NAND gate 504. Because a second input to the second NAND gate 504 from Latch_0 is ‘1’ the output of the second NAND gate 504 is ‘1’, which is inverted by a first inverter 506 so that a first digital output signal or bit (D0) is a ‘0’. Furthermore, it is seen that a second digital output signal or bit (D1) is dependent solely on the output of Latch_1, which delayed by a second inverter 508 and a third inverter 510 coupled in series to provide a delay in propagation of output from Latch_1 so that D1, in this example a ‘1’, arrives substantially concurrently with D0. Digital signals D1 and D0 are further interpreted in a logic block 512, located elsewhere in the memory 200 separate from the sub-sector 218, to provide a desired multibit binary number representing data stored in the data cell 214a. For the latch outputs described above the multibit binary number is a 2-bit binary number Data₀<D1D0>, and digital output signals D1 and D0 are further interpreted by the logic block 512 to provide a Data₀<D1D0> of <00>, as shown in a first row of FIG. 5B.

There is an area penalty for the inclusion of the logic block 512 in the overall memory 200. However, it is noted that because XOR gates include a more complex circuit than NAND gates and occupy more area, replacing the XOR gate with a NAND gate will reduce an overall area of the memory. Additionally, it is noted that because the logic block 512 can be shared by multiple or all sub-sectors 218, inclusion of the logic block is more than offset by reduced area of the local decoder 228 achieved by eliminating the XOR gate 402.

Referring again to FIGS. 5A and 5B, where I_{CMI0} is greater than I_{REF2} but less than I_{REF0} and I_{REF1}, the output of Latch_2 is ‘0’, and the output of Latch_0 and Latch_1 are both ‘1’. Because Latch_1 is ‘1’ and Latch_2 is ‘0’ the output of the first NAND gate 502 is ‘1’, and the output of the second NAND gate 504 is ‘0’, which is inverted by first inverter 506 to provide a D0 of ‘1’. Because the output of Latch_1 is ‘1’, D1 is also ‘1’. Digital output signals D1 and D0 are further interpreted by the logic block 512 to provide a Data₀<D1D0> of <01>, as shown in a second row of FIG. 5B.

Where I_{CMI0} is greater than I_{REF1} and I_{REF2} but less than I_{REF0}, the output of Latch_2 and Latch_1 are both ‘0’, and the output of Latch_0 is ‘1’. The output of the first NAND gate 502 is ‘1’, the output of the second NAND gate 504 is ‘0’, which is inverted by the first inverter 506 to provide a D0 of ‘1’. D1 like Latch_1 is ‘0’. Digital output signals D1 and D0 are further interpreted by the logic block 512 to provide a Data₀<D1D0> of <10>, as shown in a third row of FIG. 5B.

Finally, where I_{CMI0} is greater than the reference currents (I_{REF0}, I_{REF1}, and I_{REF2}) the output of all latches 226 (Latch_0, Latch_1 and Latch_2) is ‘0’, the output of the first NAND gate 502 is ‘1’, the output of the second NAND gate 504 is ‘1’, which is inverted by the first inverter 506 to provide a D0 of ‘0’. D1 like Latch_1 is ‘0’. Digital output signals D1 and D0 are further interpreted by the logic block 512 to provide a Data₀<D1D0> of <11>, as shown in a last row of FIG. 5B.

In some embodiments, the data sense amplifiers and reference sense amplifiers are single ended cell current amplifiers that include a transistor and offset cancelation mechanism to substantially eliminate errors in sense amplifier output due to process, voltage and/or temperature variations.

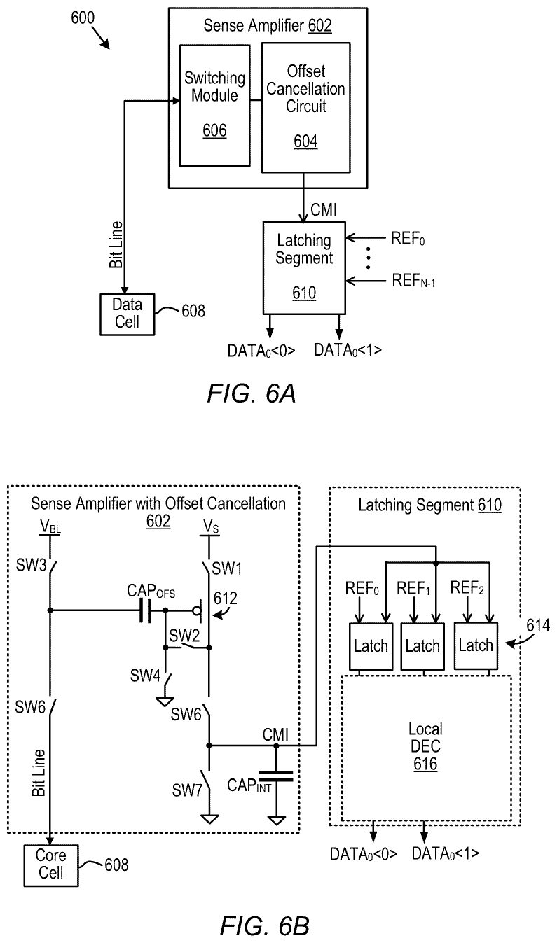

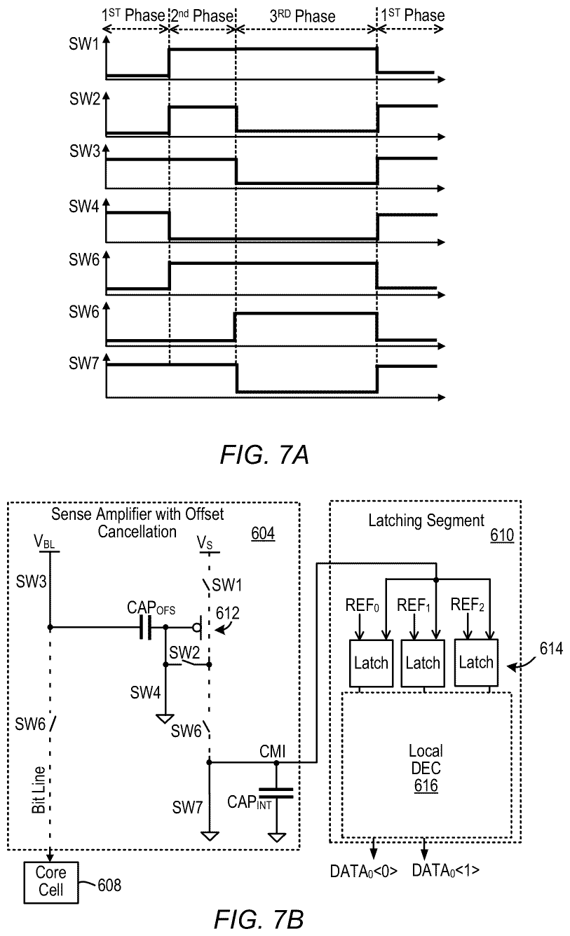

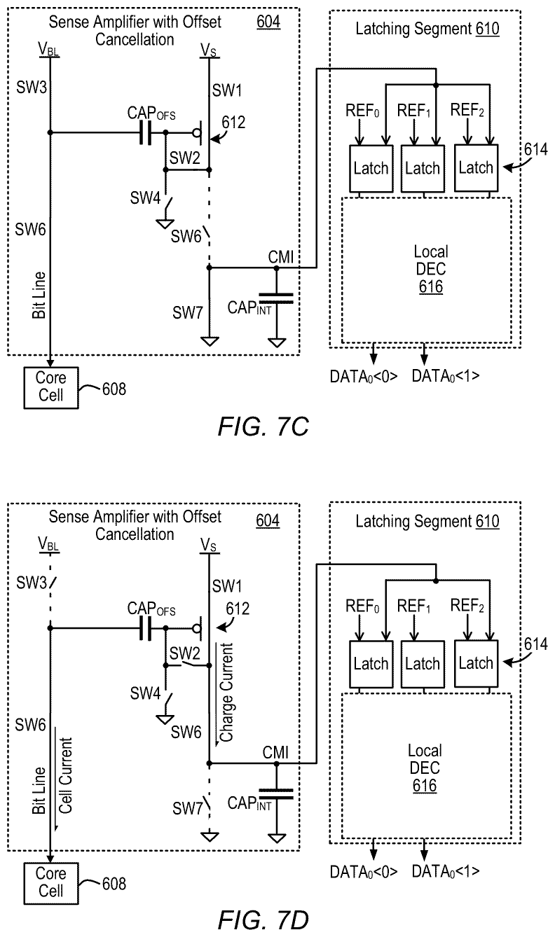

FIG. 6A is a block diagram illustrating sensing circuitry 600 with a sense amplifier 602 including an embodiment of a transistor and offset cancelation mechanism (sense amplifier with offset cancelation 604). Referring to FIG. 6A, the sense amplifier 602 further includes a switching module 606 to control operation of the sense amplifier with offset cancelation 604, and through which an input of the sense amplifier 602 is connected to a core or data cell 608. The sensing circuitry 600 further includes a latching segment 610 coupled to an output of the data sense amplifier 602. The latching segment 610 includes multiple latches (not shown in this figure) each coupled to one of multiple reference sense amplifiers providing reference signals (REF_0 to REF_2ⁿ−1) to which a core cell current (CMI) is compared. Note, although this embodiment of a single ended cell current amplifier including a transistor and offset cancelation mechanism is shown and described with reference to a data sense amplifier, it will be understood that the reference currents (REF_0 to REF_2ⁿ−1) are also generated using reference sense amplifiers coupled to reference cells, as shown in FIGS. 2A and 2B, the reference sense amplifiers can also include single ended cell current amplifiers having a transistor and offset cancelation mechanism.

FIG. 6B is a schematic block diagram of the offset cancelation and latching segments of the sensing circuitry of FIG. 6A. Referring to FIG. 6B, the sense amplifier with offset cancelation 604 includes an offset capacitor (CAP_{OFS}) having a first plate or terminal coupled through a switch (SW3) to a bit-line supply (V_{BL}), and through another switch (SW5) to a bit-line of the core cell 608. A second terminal of the offset capacitor CAP_{OFS} is coupled to gate of a PMOS gain transistor 612, and through switch (SW4) to ground. A first (source) terminal of the transistor 612 is coupled through switch (SW1) to a bit-line supply (V_{BL}), and a second (drain) terminal is coupled through switch (SW2) to the gate and to the second terminal of the offset capacitor (CAP_{OFS}), and through switch (SW6) to a first terminal or plate of an integration capacitor (CAP_{INT}) on which the output (CMI) of the sense amplifier is developed. The first terminal of the integration capacitor (CAP_{INT}) is further coupled to ground through switch (SW7), and a second plate of the integration capacitor (CAP_{INT}) is coupled to ground.

The latching segment 610 includes a number (shown here as three) of individual latches 614 a local decoding circuit or decoder 616. Each of the latches 614 is coupled to the output (CMI) of the sense amplifier 602 in parallel, and to one of the references (REF₀, REF₁, REF₂). The local decoder 616 is coupled to outputs of the latches 614, and includes combinational logic elements configured and operable to decode signals from the latches and output a multibit binary number representing data stored in the core cell 608 sensed by the sense amplifiers 602.

Generally, the sense amplifier 602 has three phases of operation including a first (1^{st}) or standby phase, a second (2^{nd}) or bit-line charging and offset cancellation phase, and a third (3^{rd}) or signal development phase. Operation of a sense amplifier including a transistor and offset cancelation mechanism will now be described with reference to FIGS. 6A through 6D, where FIG. 6A is a timing diagram illustrating switching signals provided from the switching module 606 to the sense amplifier with offset cancelation 604, and FIGS. 6B through 6D schematically illustrate the sense amplifier with offset cancelation for each phase.

Referring to FIGS. 6A and 6B, in the first or standby phase switch SW5 is opened to decouple or disable a core cell path to the core cell 608, and switch SW3 and switch SW4 are closed by to fully charge the offset capacitor (CAP_{OFS}). Switch SW7 is closed coupling the output (CMI) to ground to discharge any charge remaining on the integration capacitor (CAP_{INT}). Switch SW1, SW2 and SW6 remain open.

Referring to FIGS. 6A and 6C, in the second or bit-line charging and offset cancellation phase, switch SW5 is closed connecting the bit-line of the core cell 608 to the bit-line supply (V_{BL}), switch SW4 is opened, and switches SW1 and SW2 are closed to couple the transistor 612 to the voltage supply Vs, and turn on the transistor to discharge one side of the offset capacitor CAP_{OFS} to a voltage equal to the voltage supply Vs level minus a PMOS threshold voltage of the transistor. Thus, the offset capacitor CAP_{OFS} stores the PMOS threshold voltage with all its offsets.

Referring to FIGS. 6A and 6D, in the third or signal development phase, switches SW2, SW3 and SW7 are opened, SW5 remains closed enabling a core cell current to discharges the offset capacitor CAP_{OFS} through the bit-line and turn on the gain transistor 612. Switch SW6 is closed enabling a charge current through the gain transistor 612 to charge the integration capacitor CAP_{INT} and raise the CMI output, with a rise time proportional to the cell current level. As noted above, the rise time of the CMI signal is compared in the latching segment 610 to the reference signals (REF_0 to REF_2ⁿ−1) and coupled to the local decoder 616 to decode and output a multibit binary number representing data stored in the core cell 608.

In the embodiments shown and described above the sense amplifiers and latching segments are configured and operable to decode and output a 2-bit binary number, that is where n=2. However, it will be understood that the sense amplifier architecture and time domain sensing method described herein is highly scalable to multilevel cells (MLC) capable of storing 3-bits/cell, 4-bits/cell or more, while maintaining fast sensing speeds of ~10 ns of less, and with minimal area impact and a low power operation.

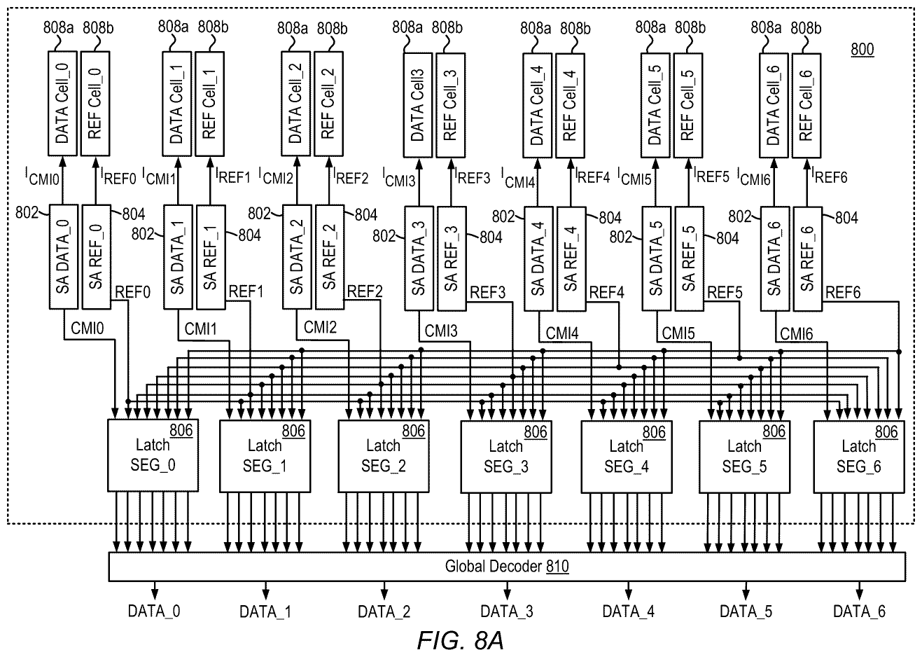

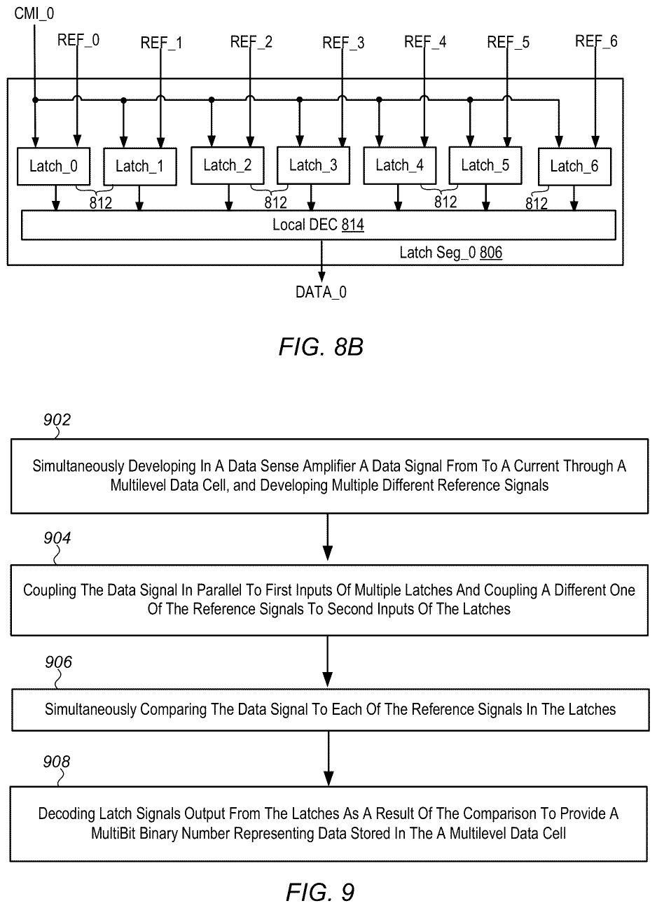

FIG. 8A is a schematic block diagram of another embodiment of a sub-sector 800 configured and operable to enable three-bit per cell (3-bit/cell) sensing. Referring to FIG. 8, where n=3 the sub-sector 800 includes with 2³−1 or seven (7) data sense amplifiers 802, and an equal number of reference sense amplifiers 804 and latching segments 806. Generally, as in the embodiment described above the data sense amplifiers 802 and reference sense amplifiers 804 are open or single ended current sense amplifiers with transistor and offset cancelation mechanisms as described above. Each of the data sense amplifiers 802 are selectively coupled through a bit-line to one of multiple data cells 808a in a memory core or array, and are operable to output a common mode insensitive (CMI) signal having a rise time proportional to a data cell current (I_{CMI}) through the bit-line. Similarly, each of the reference sense amplifiers 804 are coupled to a bit-line of one of a number of reference cells 808b, are operable to output a reference (REF) signal having a rise time proportional to a reference cell current (I_{REF}). Each of the latching segments 806 includes multiple individual latches (not shown in this figure) equal to the number of data sense amplifiers 804 and reference sense amplifiers 804.

In some embodiments, such as that shown, the outputs of the latching segments 806 are coupled to a global decoding circuit or decoder 810 configured and operable to decode signals from the latches of each of the seven (7) latching segments and output a 3-bit binary number representing data stored in a data cell 808a. Generally, the global decoder 810 is similar to the local decoder 228 shown in FIG. 2B, but includes a larger number of logic gates and elements. The global decoder 810 can be included within or associated with each sub-sector 800, or it can be implemented in a main logic block (not shown) in the flash memory configured to serve multiple sub-sectors thereby further reducing area impact of the multilevel sensing circuitry of the present disclosure.

A schematic block diagram of one latching segment 806 of the sub-sector 800 of FIG. 8A is shown in FIG. 8B. Referring to FIG. 8B the latching segment 806 includes seven (7) latches 812, each including a first input coupled in parallel to an output of a single one of the data sense amplifiers 802, and a second input coupled to an output of a different one of the reference sense amplifiers 804. Each of the latches 812 in the latching segment 806 are operable to simultaneously receive and compare the data signal (CMI) received from one of the data sense amplifiers 802 and one of the reference signals (REF_0 through REF_6) from one of the reference sense amplifiers 804.

In some embodiments, such as that shown, each of the latching segments 806 further include a local decoding circuit or decoder 814 coupled to outputs of the latches 812. The local decoder 814 includes combinational logic configured and operable to decode signals from the latches and output a 3-bit binary number representing data stored in the data cell 808a.

A method for operating a high speed multilevel sensing circuitry in flash memories will now be described with reference to the flowchart FIG. 8. Referring to FIG. 8 the method begins with developing in a data sense amplifier a data signal (CMI) from a current (I_{CMI}) through a multilevel data cell capable of storing n bits of data, while concurrently developing a plurality of reference signals, each different from the others (902). As noted above, the number of the plurality of reference signals is m, which is equal to 2ⁿ−1, where n is the number of bits of data which can be stored in the multilevel data cell MLC. Preferably, the data sense amplifier includes a transistor and offset cancelation mechanism, and the data signal is developed using the three phase time domain sensing method as described with reference to FIGS. 6A-5D. Similarly, where the m different reference signals are developed from m different reference sense amplifiers, each of the reference sense amplifiers can also include a transistor and offset cancelation mechanism, and the n reference signals can be developed using the three phase time domain sensing method as described above.

Next, the data signal is coupled in parallel to first inputs of a plurality of latches while a different one of each of the reference signals to second inputs of the latches (904). It is noted that because the data and reference signals have a rise time proportional to current through the cell, it is important when using time domain sensing that the coupling of the data signal and the n reference signals is accomplished at the same time. It is further desirable that a data path coupling the data cell to the data sense amplifier, and the data sense amplifier to n latches are substantially electrically matched to the reference paths coupling the reference cells to the reference sense amplifiers and to the m latches.

The data signal is simultaneously compared to each of the m reference signals in each of the m latches, and m latch signals resulting from the comparison output from each of the latches (906).

Finally, the m latch signals output from the latches as a result of the comparison are decoded to provide a multibit (n-bit) binary number representing data multibit stored in the a multilevel data cell (908).

Thus, sense amplifier and method are provided for high speed multilevel sensing in a flash memory have been disclosed. Embodiments of the present invention have been described above with the aid of functional and schematic block diagrams illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be understood that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A circuit for sensing data stored in a multilevel data cell, the circuit comprising:
a data sense amplifier (SA) with an input switchably coupled to one of a plurality of multilevel data cells (MLC) in an array of a flash memory, the data SA operable to receive a data current therefrom and to develop a data signal from the data current received;
a number (m) of reference sense amplifiers (SAs), each reference sense amplifier having an input coupled to a different one of a plurality of reference cells in the array, each of the reference SAs operable to receive a reference current from the reference cell couple thereto and to develop one of m different reference signals therefrom; and
a latching segment comprising m latches, each latch having a first input coupled to the data SA and a second input coupled to a different one of the m reference SAs, each of the m latches operable to simultaneously receive and compare the data signal with one of the m different reference signals received from one of the m reference SAs, and to output one of m latching signals, wherein the m latching signals are collectively decoded to convert to a n-bit binary number representing multibit data stored in the one of the plurality of MLC,
wherein m is equal to 2ⁿ−1 and n is the number of bits in the n-bit binary number.

2. The circuit of claim 1 wherein the latching segment further comprises a local decoder coupled to outputs of the m latches to convert the m latching signals into the n-bit binary number.

3. The circuit of claim 1 comprising m data SAs and m latching segments, each of the m data SAs having an input switchably coupled to a different one of the plurality of MLCs and an output coupled in parallel to the m latches in a different one of the m latching segments, wherein the circuit is operable to simultaneously sense multibit data stored in m MLCs.

4. The circuit of claim 3 wherein each of the m data SAs and each of the m reference SAs are electrically coupled to an equal number of latches in the m latching segments.

5. The circuit of claim 3 further including a global decoder coupled to outputs of the m latches in all m latching segments to convert the m latching signals from each of the m latching segments into m n-bit binary numbers.

6. The circuit of claim 3 further comprising a total of m local decoders, each coupled to outputs of the m latches in one of the m latching segments, and operable to convert the m latching signals into the n-bit binary number.

7. The circuit of claim 3 wherein data paths coupling the plurality of MLCs to the m data SAs and reference paths coupling the plurality of the reference cells to the m reference SAs are electrically matched.

8. The circuit of claim 1 wherein n is 2, m is 3, and the circuit is operable to output 3 latching signals that when collectively decoded converts the 3 latching signals in to a 2-bit binary number representing the multibit data stored in the MLC.

9. The circuit of claim 1 wherein n is 3, m is 7, and the circuit is operable to output 7 latching signals that when collectively decoded converts the 7 latching signals in to a 3-bit binary number representing the multibit data stored in the MLC.

10. The circuit of claim 1 wherein the data SA comprises a single ended current sense amplifier (current SAs) including a switching module and an offset cancelation circuit, the offset cancelation circuit comprising:
an integration capacitor (CAP_{INT}) having a first terminal on which the data signal is developed and second terminal coupled to ground;
a transistor having a source switchably coupled to a voltage supply (Vs) and a drain switchably coupled to the first terminal of the CAP_{INT}; and
an offset capacitor (CAP_{OFS}) having a first terminal switchably coupled to a bit-line voltage (V_{BL}) and switchably coupled through a bit-line to the MLC, and a second terminal coupled to a gate of the transistor and switchably coupled to a drain of the transistor and to ground.

11. The circuit of claim 10 wherein the switching module is operable to:
in a first phase of signal development to decouple the MLC from the CAP_{OFS}, couple the first terminal of the CAP_{OFS} to V_{BL} and couple the second terminal to ground to charge the CAP_{OFS}, and couple the first terminal of CAP_{INT} to discharge the CAP_{INT};
in a second phase to switch the second terminal of the CAP_{OFS} from ground to the drain of the transistor, couple the MLC to the first terminal of the CAP_{OFS} and to V_{BL}, and to couple the source of the transistor to Vs, to discharge the second terminal of the CAP_{OFS} to a voltage equal to Vs minus a threshold voltage (V_{TH}) of the transistor; and
in a third phase decoupling the MLC and the first terminal of the CAP_{OFS} from the V_{BL}, decoupling the second terminal of the CAP_{OFS} from the drain of the transistor, and coupling the drain of the transistor to the CAP_{INT}, whereby a cell current through the MLC discharges the CAP_{OFS} while the second terminal of the CAP_{OFS} coupled to the gate controls a charge current through the transistor to develop a data signal on the CAP_{INT} having a rise time proportional to the cell current.

12. The circuit of claim 1 wherein each of the reference SAs is operable to receive the reference current from the reference cell couple thereto and to develop one of m different reference signals therefrom concurrently with the data SA receiving the data current and developing the data signal.

13. A method for reading data stored in a non-volatile memory (NVM), the method comprising:
developing in a data sense amplifier (SA) a data signal from a cell current through one of a plurality of multilevel cell (MLCs) in the NVM;
developing m different reference signals from m different reference cells, where m equals 2ⁿ−1, and n is a number of bits of data stored in the plurality of MLCs;
coupling the data signal in parallel to first inputs of m latches in a latching segment, and coupling a different one of the m different reference signals to second inputs of the m latches;
simultaneously comparing the data signal to each of the m different reference signals in the m latches, and outputting m latch signals, one from each of the m latches; and
decoding the m latch signals to provide an n-bit binary number representing data stored in the one of the plurality of MLCs.

14. The method of claim 13 wherein the data SA is a single ended current SA comprising a transistor and an offset cancelation circuit including an offset capacitor (CAP_{OFS}) having a first terminal coupled to the one of the plurality of MLCs and an integration capacitor (CAP_{INT}), and wherein developing the data signal comprises:
in a first phase decoupling the one of the plurality of MLCs from the CAP_{OFS}, charging the CAP_{OFS} and discharging the CAP_{INT};
in a second phase coupling the one of the plurality of MLCs and the first terminal of the CAP_{OFS} a bit-line voltage (V_{BL}), coupling a source of the transistor to a voltage supply (Vs), and coupling a second terminal of the CAP_{OFS} to a gate and drain of the transistor to discharge the second terminal of the CAP_{OFS} to a voltage equal to Vs minus a threshold voltage (V_{TH}) of the transistor; and
in a third phase decoupling the one of the plurality of MLCs and the first terminal of the CAP_{OFS} from the V_{BL}, decoupling the second terminal of the CAP_{OFS} from the drain of the transistor, and coupling the drain of the transistor to the CAP_{INT}, whereby a cell current through the one of the plurality of MLCs discharges the CAP_{OFS} while the second terminal of the CAP_{OFS} coupled to the gate controls a charge current through the transistor to develop the data signal on the CAP_{INT} having a rise time proportional to the cell current.

15. The method of claim 13 wherein developing m different reference signals from m different reference cells, comprises developing m different reference signals in m different reference SAs, and wherein each of the data SAs are single ended current SAs comprising a transistor and an offset cancelation circuit.

16. The method of claim 13 wherein the NVM comprises m data SAs and m latching segments, each of the m data SAs having an input switchably coupled to a different one of the plurality of MLCs and an output coupled in parallel to the m latches in a different one of the m latching segments, wherein the method comprises simultaneously sensing data stored in m MLCs.

17. The method of claim 16 wherein the NVM further comprises a global decoder coupled to outputs of the m latches in all m latching segments, and wherein decoding the m latch signals comprises simultaneously converting the m latching signals from each of the m latching segments into m n-bit binary numbers.

18. The method of claim 16 wherein developing m different reference signals is accomplished concurrently with developing the data signal.

19. A sense amplifier for sensing data stored in a non-volatile memory (NVM), the sense amplifier including an offset cancelation circuit comprising:
an integration capacitor (CAP_{INT}) having a first terminal on which a data signal is developed and second terminal coupled to ground;
a transistor having a source switchably coupled to a voltage supply (Vs) and a drain switchably coupled to the first terminal of the CAP_{INT}; and
an offset capacitor (CAP_{OFS}) having a first terminal switchably coupled to a bit-line voltage (V_{BL}) and switchably coupled through a bit-line to a core cell in the NVM, and a second terminal coupled to a gate of the transistor and switchably coupled to a drain of the transistor and to ground.

20. The sense amplifier of claim 19 further comprising a switching module operable to:
in a first phase of signal development to decouple the core cell from the CAP_{OFS}, couple the first terminal of the CAP_{OFS} to V_{BL} and couple the second terminal to ground to charge the CAP_{OFS}, and couple the first terminal of CAP_{INT} to discharge the CAP_{INT};
in a second phase to switch the second terminal of the CAP_{OFS} from ground to the drain of the transistor, couple the core cell to the first terminal of the CAP_{OFS} and to V_{BL}, and to couple the source of the transistor to Vs, to discharge the second terminal of the CAP_{OFS} to a voltage equal to Vs minus a threshold voltage (V_{TH}) of the transistor; and
in a third phase decoupling the core cell and the first terminal of the CAP_{OFS} from the V_{BL}, decoupling the second terminal of the CAP_{OFS} from the drain of the transistor, and coupling the drain of the transistor to the CAP_{INT}, whereby a cell current through the core cell discharges the CAP_{OFS} while the second terminal of the CAP_{OFS} coupled to the gate controls a charge current through the transistor to develop a data signal on the CAP_{INT} having a rise time proportional to the cell current.
